(19) United States
(12) Patent Application Publication
(10) Pub. No.: US 2005/0251813 A1
(43) Pub. Date: Nov. 10, 2005

(54) Optical disc drive with reduced weight design

(75) Inventor: Hsien-Tsung Chiu, Kweishan (TW)

Correspondence Address: Richard P. Berg, Esq.;c/o LADAS & PARRY, Suite 2100, 5670 Wilshire Boulevard, Los Angeles, CA, 90036-5679, US

(73) Assignee: BENQ CORPORATION

(21) Appl. No.: 11/111,687

(22) Filed: Apr. 20, 2005

(30) Foreign Application Priority Data
Apr. 21, 2004 (TW) 093111164

(51) Int. Cl. G11B 17/03; G11B 17/04; G11B 33/02

(52) U.S. Cl. 720/601

(57) ABSTRACT

The present invention provides an optical disc drive that comprises a loader, a top case, and a bottom case. The loader is used for loading electronic parts of the optical disc drive. The top case covers the loader to form a top exterior of the optical disc drive. The bottom case covers the loader to form a bottom exterior of the optical disc drive. The top and bottom cases can be detached from the loader. A left side and a right side of the loader form the left exterior and the right exterior of the optical disc drive respectively.

### BACKGROUND OF THE INVENTION

1. Field of the Invention

The present invention relates to a weight-reduced design especially to an optical disc drive with weight-reducing design.

2. Description of the Prior Art

The structure of optical disc drives of the prior art, like CD-ROM and CD-R, is approximately the same, and the difference in exterior is not great either.

The optical disc drive consists of a loader, a top case, and a bottom case. The loader is for loading a plurality of electronic components of the optical disc drive. The top case and the bottom case form a top exterior, a bottom exterior, a left exterior, and a right exterior. In addition, some external optical disc drives have an extra outer-case to enhance its appearance.

Whether it is an external or an internal optical disc drive, all apparatuses follow the trend of being light and small. Therefore, how to reduce the weight, to simplify the structure, and to reduce the cost become an important aspect of research and development.

### SUMMARY OF THE INVENTION

The objective of the present invention is to provide a weight-reducing design for an optical disc drive.

The present invention is an optical disc drive that comprises a loader, a top case, and a bottom case. The loader is for loading a plurality of electronic components on the optical disc drive; the top case is for detachably covering the top of the loader to form a top exterior of the optical disc drive, and the bottom case is for detachably covering the bottom of the loader to form a bottom exterior of the optical disc drive. A left side and a right side of the loader are a left exterior and a right exterior of the optical disc drive.

The present invention is an optical disc drive, the left side and right side of the loader are the left exterior and right exterior of the optical disc drive, thus greatly reducing the weight of the optical disc drive and enlarging the internal space in the loader for installing internal parts. In addition, the present invention is an optical disc drive that does not need to install an external case when it is applied as an external apparatus, so that can reduce the cost.

The advantage and spirit of the invention may be understood by the following recitations together with the appended drawings.

### BRIEF DESCRIPTION OF THE APPENDED DRAWINGS

FIG. 1 is an external view of an optical disc drive of the present invention.

FIG. 2 is a blown-up view of the optical disc drive in FIG. 1.

FIG. 3 is an enlarged view of a part of the optical disc drive.

FIG. 4 is an external view of an optical disc drive of another embodiment of the present invention.

FIG. 5 is an external view of an optical disc drive installed in a computer.

FIG. 6 is a blown-up view of the optical disc drive in FIG. 5.

### DETAILED DESCRIPTION OF THE INVENTION

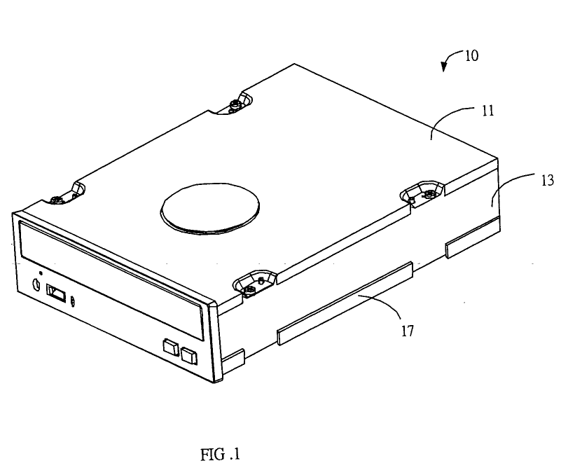

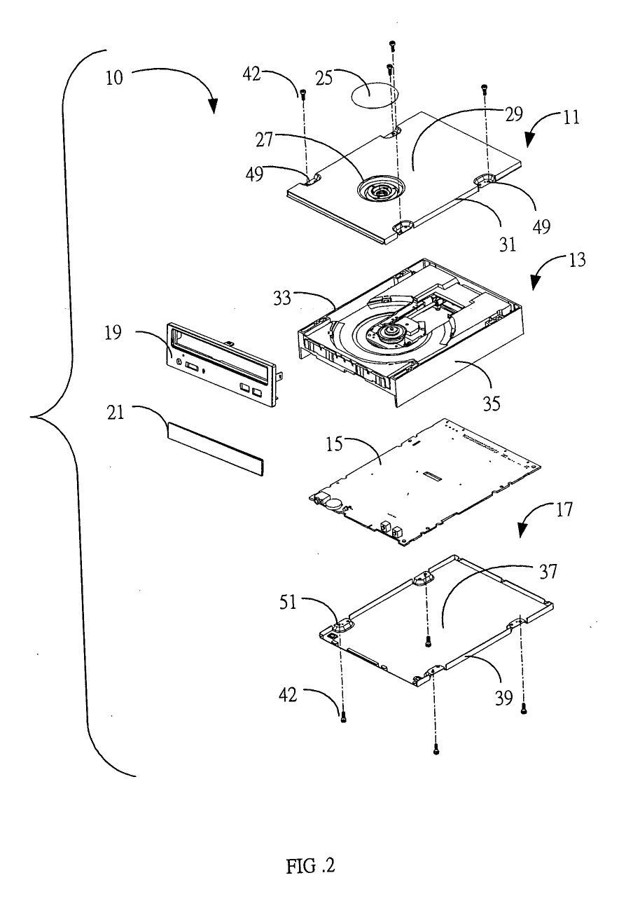

Please refer to FIG. 1 and FIG. 2. FIG. 1 is an external view of an optical disc drive 10 of the present invention, and FIG. 2 is a blown up view of the optical disc drive 10 in FIG. 1. The optical disc drive 10 comprises a top case 11, a loader 13, a printed circuit board 15, a bottom case 17, a panel 19, a cover 21, a top plate 25, and a clamper assembly 27.

The loader 13 is for loading a plurality of electronic components of the optical disc drive 10. These electronic components are mainly for reading/writing data on a compact disk. The loader 13 is a monolithically formed mechanism. A left side 33 and a right side 35 of the loader 13 form the left exterior and the right exterior of the optical disc drive 10.

The top case 11 is for detachably covering the top of the loader 13 to form a top exterior of the optical disc drive 10. The top case 11 comprises a first base 29 and at least two first bending parts 31. The bottom case 17 is for detachably covering the bottom of the loader 13 to form the bottom exterior of the optical disc drive 10. The bottom case 17 comprises a second base portion 37 and at least two second bending parts 39.

After the optical disc drive 10 is assembled, the top case 11 and the bottom case 17 respectively form a top exterior and a bottom exterior of the optical disc drive 10; a left side 33 and a right side 35 of the loader 13 form a left exterior and a right exterior of the optical disc drive 10. The two first bending parts 31 of the top case extend downward from the two sides of the base portion 29 in the proximity of the left exterior and the right exterior and engage with the left exterior 33 and the right exterior 35 respectively; however, they do not substantially cover the left side 33 and right side 35 of the loader 13.

In addition, a clamper assembly 27 is allocated at the first base of the top case 111 for holding a compact disk (not shown in the diagram) in the optical disc drive 10. A top plate 25 is for holding the clamper assembly 27 in the top case 11. The top plate 25 and clamper assembly 27 are both detachably installed on the top case 11.

The printed circuit board 15 is the base plate for loading the electronic components, and the electronic components may transmit information to each other. The printed circuit board 15 is fixed underneath the loader 13, and then the bottom case 17 is installed to cover the bottom of the loader 13. In addition, the panel 19 and cover 21 are engaged on the front of the loader 13 to form a front exterior of the optical disc drive 10.

In the optical disc drive 10 of the present invention, the left side 33 and right side 35 of the loader 13 are the left exterior and right exterior of optical disc drive 10, thus reducing a lot of weight and cost. The two sides 33 and 35 are more outwardly extended than the prior art, so the internal space in the loader 13 is enlarged and is helpful in the application of internal components.

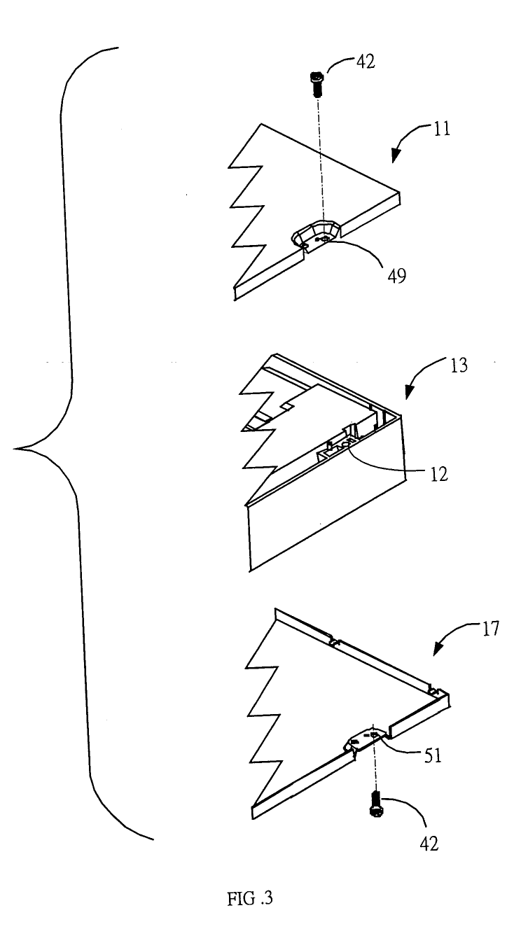

Please refer to FIG. 3. FIG. 3 is an enlarged view of a part of the optical disc drive 10 of the present invention. The loader 13 comprises a plurality of positioning parts, like a plurality of hollow tubes 12 and a plurality of first screws 42 in FIG. 3. The top case 11 comprises a plurality of first engaging parts of a plurality of corresponding positioning parts, like the plurality of first holes 49 in FIG. 3; the bottom case 17 comprises a plurality of second engaging parts of a plurality of corresponding positioning parts, like the plurality of second holes 51 in FIG. 3, wherein a plurality of first screws 42 are respectively locked into the plurality of hollow tubes 12 through the first holes 49 and the second holes 51 for fixing the top case 11 and bottom case 17 onto the loader 13.

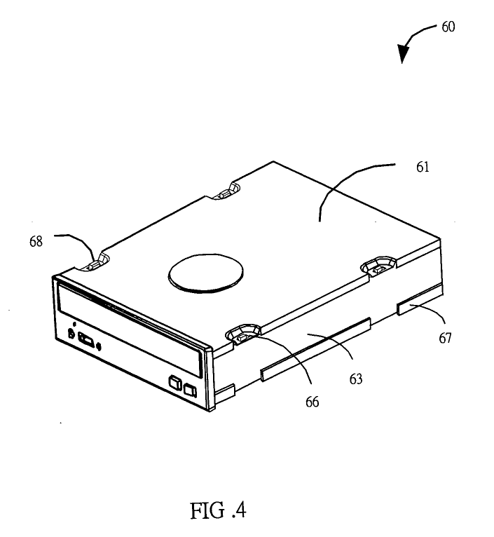

Please refer to FIG. 4; FIG. 4 is an external view of a optical disc drive 60 of another embodiment of the present invention. The main difference between the optical disc drive 60 of FIG. 4 and the optical disc drive 10 of FIG. 1 is that the plurality of positioning parts of the loader 63 are a plurality of hooks 68. Each of the top case and bottom case comprises a plurality of first holes 66 and a plurality of second holes (not shown in diagram), which are engaging parts, corresponding to the plurality of hooks 68, wherein the hooks 68 respectively engage with the first wedging parts 66 and second wedging parts respectively for fixing the top case 61 and bottom case 67 onto the loader 63. It should be understood that the positioning parts, hollow tubes 12 and a plurality of first screws 42 in FIG. 3, or hooks 68 in FIG. 4, can be replaced by any male/female structure; the first and second engaging parts corresponding to the positioning parts can be replaced by any female/male structure.

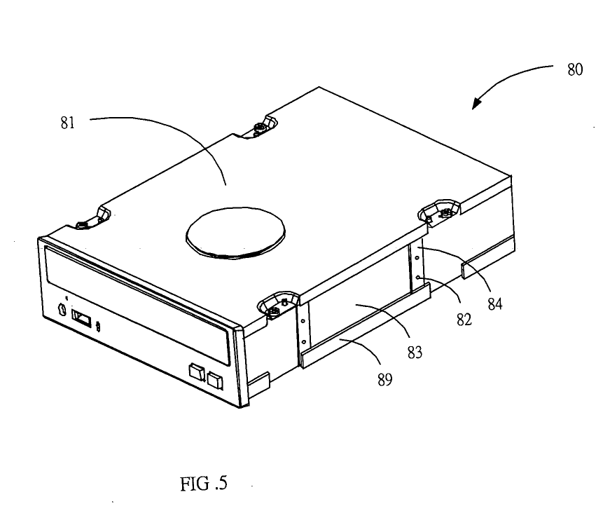

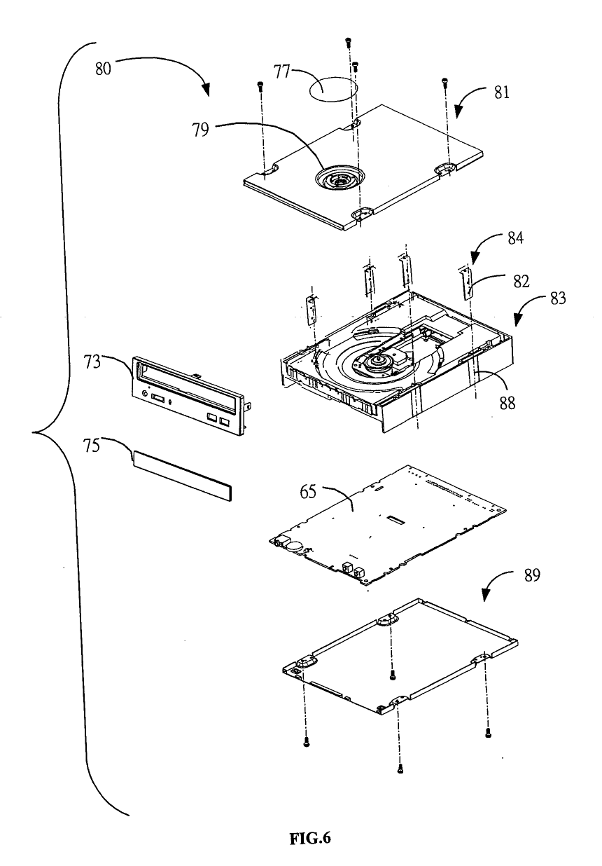

Please refer to FIG. 5 and FIG. 6; FIG. 5 is an external view of a optical disc drive 80 installed in a computer, and FIG. 6 is a blown up view of the optical disc drive 80 in FIG. 5. The optical disc drive 80 can be installed in a computer, and the computer comprises a support (not shown in diagram) for fixing the optical disc drive 80 in place.

Comparing with the exterior of the optical disc drive 10 of FIG. 1, a plurality of supporting plates 84 are installed on the left side and right side of the loader 83 of the optical disc drive 80. Each of the supporting plate 84 comprises at least one screw nut 82, so that user can utilize a plurality of second screws (not shown) locking into the screw nuts 82 to fix the optical disc drive 80 on the fixing support (not shown). The left side and the right side of the loader 83 comprise a plurality of indents 88 for putting in the supporting plates 84. The supporting plates 84 will not obviously stick out from the side of the loader 83 when the supporting plates 84 are installed on the loader 83.

When the assembling of the optical disc drive is almost completed, the supporting plates 84 are first put on the loader 83; then, the top case 81 and bottom case 89 are put in. The method of putting in the top case 81, bottom case 89, the assembling of the printed circuit board 65, panel 73, cover 75, top-plate 77, and clamper assembly 79 of the optical disc drive 80 are similar to the aforementioned method, so it will not be explained again.

In the different embodiments of FIG. 1 and FIG. 4, both of them can use the method of supporting plates to fix the optical disc drive 10 and 60 on the computer. The methods of putting in of the supporting plates, the assembling of the optical disc drive, and the installing of the optical disc drive into computer are all similar to FIG. 5 and FIG. 6, so it will not be explained again.

Comparing with the optical disc drive of the prior art, left side and right side of the loader are the left exterior and the right exterior of the optical disc drive, thus greatly reducing the weight and cost of the optical disc drive and enlarging the internal space in the loader for installing internal parts. In addition, the design of the optical disc drive of the present invention can be used as both internal apparatus and external apparatus, and it does not need to install an external case when it is applied as the external apparatus, so it not only reduces the volume and size of the external apparatus but also reduces the cost of production.

With the example and explanations above, the feature and spirits of the invention will be helpfully well described. Those skills in the art will readily observe that numerous modification and alterations of device may be made while retaining the teaching of the invention. According, the above disclosure should be construed as limited only by the metes and bounds of the appended claims.

1. An optical disc drive comprising
a loader for loading a plurality of electronic components of the optical disc drive;
a top case detachably covering the loader to form a top exterior of the optical disc drive; and
a bottom case detachably covering the loader to form a bottom exterior of the optical disc drive;
wherein a left side and a right side of the loader are a left exterior and a right exterior of the optical disc drive, respectively.

2. The optical disc drive of claim 1, wherein the loader is a monolithically formed mechanism.

3. The optical disc drive of claim 1, wherein the top case includes a first base with at least two first bending parts which extend laterally from the first base to the left exterior and the right exterior, and engage with but not substantially cover the left exterior and the right exterior respectively.

4. The optical disc drive of claim 3, wherein a clamper assembly is allocated at the first base for holding a compact disk in the optical disc drive.

5. The optical disc drive of claim 1, wherein the bottom case comprises a second base with at least two second bending parts which extend laterally from the second base to the left exterior and the right exterior, and engage with but not substantially cover the left exterior and the right exterior respectively.

6. The optical disc drive of claim 1, wherein the loader has a plurality of positioning parts, the top case includes a plurality of first engaging parts corresponding to the positioning parts for fixing the top case to the loader, and the bottom case also includes a plurality of second engaging parts corresponding to the positioning parts for fixing the bottom case to the loader.

7. The optical disc drive of claim 6, wherein the first engaging parts are a plurality of first holes, the second engaging parts are a plurality of second holes, and the positioning parts include a plurality of hollow tubes and first screws used for locking into the hollow tubes through the first holes and the second holes.

8. The optical disc drive of claim 6, wherein the first engaging parts are a plurality of first holes, the second engaging parts are a plurality of second holes, and the positioning parts are a plurality of hooks mutually engaging with the first and the second holes.

9. The optical disc drive of claim 6, wherein the optical disc drive is accommodated in a computer, and the computer includes a support for fixing the optical disc drive thereon.

10. The optical disc drive of claim 9, wherein at least one supporting plate is allocated at the left side and at the right side of the loader respectively, and the supporting plate includes at least one screw nut, so that a plurality of second screws are utilized to lock into the screw nuts to fix the optical disc drive on the fixing support.
